(19) United States
(12) Patent Application Publication
(10) Pub. No.: US 2026/0099750 A1
(43) Pub. Date: Apr. 9, 2026

(54) QUANTUM COMPUTING ARRANGEMENT AND QUANTUM COMPUTER

(71) Applicant: eleQtron GmbH, Siegen (DE)

(72) Inventors: Michael Johanning, Siegen (DE); Sebastian Bock, Berlin (DE); Pedram Yaghoubi, Siegen (DE); Patrick Huber, Herdorf (DE); Patrick Barthel, Burbach (DE); Christof Wunderlich, Siegen (DE); Theeraphot Sriarunothai, Siegen (DE)

(21) Appl. No.: 19/114,201

(22) PCT Filed: Sep. 26, 2023
(86) PCT No.: PCT/EP2023/076540

§ 371 Date: Mar. 21, 2025

(30) Foreign Application Priority Data
Sep. 26, 2022 (DE) 10 2022 124 694.9

(51) Int. Cl. G06N 10/40

(52) U.S. Cl. CPC G06N 10/40

(57) ABSTRACT

In an embodiment a quantum computing arrangement includes a permanent magnet arrangement configured for establishing a magnetic field with magnitudes different from one another for different positions on a first axis, a space for at least two trapped quantum particles arranged along the first axis and a soft magnetic material surrounded by the permanent magnet arrangement, the soft magnetic material configured for enhancing the magnetic field, wherein the permanent magnet arrangement comprises a plurality of segments, wherein each segment has a magnetisation direction, and wherein the segments surround the space in form of a ring, or wherein the segments surround the space in form of a contour of a polygon.

### CROSS-REFERENCE TO RELATED APPLICATIONS

This patent application is a national phase filing under section 371 of PCT/EP2023/076540, filed Sep. 26, 2023, which claims the priority of German patent application no. 102022124694.9, filed Sep. 26, 2022, each of which is incorporated herein by reference in its entirety.

### TECHNICAL FIELD

The present disclosure relates to a quantum computing arrangement and a quantum computer.

### BACKGROUND

For many quantum computing processes using quantum computing arrangements, the arrangements can be configured to trap trapped quantum particles. The trapped quantum particles have to be controlled and manipulated in order to perform calculations. For charged trapped quantum particles, an interaction as e.g. Coulomb repulsion creates a coupling of neighbouring trapped quantum particles and enables entanglement. Thus, in order to perform quantum computing processes using the trapped quantum particles, the trapped quantum particles have to be controllable and addressable individually from one another.

An individual addressing of a plurality of trapped quantum particles, e.g. a quantum bit register, is desirable with negligible crosstalk. However, a crosstalk between neighbouring trapped quantum particles is typically a difficult source of error to control in quantum computer processes and can prevent a meaningful application of quantum error correction protocols and thus a scalability.

### SUMMARY

Embodiments provide a quantum computing arrangement having an improved controllability. Further embodiments provide a quantum computer comprising such a quantum computing arrangement.

According to at least one embodiment, the quantum computing arrangement comprises a permanent magnet arrangement configured to establish a magnetic field with magnitudes being different from one another for different positions on a first axis. Exemplarily, the magnitude of the magnetic field changes along the first axis for different positions on the first axis. The magnitude is, for example, symmetrical with respect to the centre of the permanent magnet arrangement along the first axis. This is to say that there are two points with identical magnitude on the first axis, for example.

The permanent magnet arrangement has a main extension plane, wherein the first axis extends along the main extension plane. The first axis is a virtual axis. The first axis is, for example, an axisymmetric axis within the main extension plane. This is to say that the first axis splits the permanent magnet arrangement in cross-sectional view along the main extension plane in two halves and a shape of the two halves is essentially identical. “Essentially identical” means exemplarily that due to manufacturing tolerances of the permanent magnet arrangement, the halves, e.g. an area of the cross sections of the halves, can differ at most by 5% or at most by 1% to one another.

The permanent magnet arrangement is configured to generate a magnetic multipole field. In particular, a magnetic quadrupole field is generated wherein in a centre of the permanent magnet arrangement the magnitude of the magnetic field is vanishing, e.g. is approximately o T. Due to the magnetic multipole field, particularly due to the quadrupole field, the magnitudes of the magnetic field are different for different positions on the first axis.

For such a permanent magnet arrangement, the magnitude of the magnetic field changes continuously along the first axis, i.e. for different positions on the first axis starting in the centre. Thus, the magnitudes of the magnetic field for different positions on the first axis are characteristic for a magnetic field gradient along the first axis.

The magnetic field is represented by a magnetic flux density. Further, an absolute value of the magnetic flux density corresponds to the magnitude of the magnetic field for a predetermined position on the first axis.

Components of the magnetic field correspond to components of vectors, wherein the vectors can point in any direction with respect to the first axis. This is to say that at least some of the vectors of the magnetic field for different positions on the first axis can have different angles with respect to the first axis. For example, at least some of the vectors of the magnetic field point in radial direction of the first axis or in axial direction of the first axis.

For example, at least some of the vectors of the magnetic field point in the same radial direction and/or in the same axial direction of the first axis for different positions on the first axis. Alternatively or additionally, at least some of the vectors of the magnetic field are rotated in radial direction of the first axis with respect to one another.

A distribution of the magnitude of the magnetic field is symmetric with respect to the centre of the permanent magnet arrangement along the first axis. Exemplarily, the first axis is split into two halves by the centre of the permanent magnet arrangement. The magnitude of the magnetic field has a negative slope for one half and a positive slope for the other half. The magnetic field gradient grows along the first axis, with respect to the magnitude of the magnetic field along the first axis, for example, approximately linearly. Deviations of at most 5% from the linearity can be present due to production tolerances of the permanent magnet arrangement, exemplarily, within the centre region. This is to say that the magnetic field gradient is approximately constant along the first axis starting from the centre.

According to at least one embodiment, the quantum computing arrangement comprises a space for at least two trapped quantum particles arranged along the first axis. This is to say that in operation of the quantum computing arrangement, the at least two trapped quantum particles are arranged along the first axis. Exemplarily, the space has a main extension direction extending along the first axis.

For example, the permanent magnet arrangement surrounds the space. The space is defined as an area or volume, being surrounded by the permanent magnet arrangement, where the quantum particles are trapped during operation of the quantum computing arrangement. Exemplarily, the trapped quantum particles are arranged linearly next to one another along the first axis during operation of the quantum computing arrangement. In particular, during operation of the quantum computing arrangement more than two, e.g. at least 8, at least 20 or at least 100 and/or at most 1000, trapped quantum particles are arranged along the first axis.

The trapped quantum particles are represented, for example, by energy levels in atoms or molecules, by spins of electrons and/or nuclei, charges, fluxes or phases in superconductors or topological quantum numbers of anyons in a topological protected system.

For example, the space is located within a vacuum environment and/or a cryogenic environment.

Exemplarily, each trapped quantum particle is trapped by a predetermined trap potential. The trap potential can be static or dynamic. For trapped quantum particles represented by energy levels in atoms or molecules, ions are trapped by electromagnetic fields. Exemplarily, ions are trapped by dynamic electric fields, particularly radio frequency fields. For trapped quantum particles represented by the spins of electrons, electrons are trapped in a potential well within a semiconductor system.

According to at least one embodiment of the quantum computing arrangement, the permanent magnet arrangement comprises a soft magnetic material being surrounded by the permanent magnet arrangement configured to enhance the magnetic field established by the permanent magnet arrangement. For example, the soft magnetic material is arranged on the first axis, i.e. has an overlap with the first axis at some regions.

For example, the soft magnetic material has a coercivity being at most 1000 A/m. Such a soft magnetic material is configured to be magnetised in a magnetic field particularly well, leading to a magnetic polarisation of the soft magnetic material. The magnetic polarisation of the soft magnetic material is achieved by the magnetic field of the permanent magnet arrangement. The magnetic polarisation of the soft magnetic material provides a magnetic field component of the magnetic field in a region of the soft magnetic material which is bigger than a component of the magnetic field of the permanent magnet arrangement itself in the region of the soft magnetic material. Thus, the soft magnetic material enhances the magnetic field of the permanent magnet arrangement, in particular in the region of the soft magnetic material. This is to say that also the magnetic field gradient along the first axis is enhanced.

For example, the soft magnetic material is located within a vacuum environment and/or a cryogenic environment.

It is an idea, inter alia, to use the permanent magnet arrangement in combination with the soft magnetic material being surrounded by the permanent magnet arrangement. The different magnitudes of the magnetic field, i.e. the magnetic field gradient of the permanent magnet arrangement, makes equilibrium positions of the trapped quantum particles state dependent. Furthermore a resonance frequency is unique for each trapped quantum particle due to the magnetic field gradient.

A coupling of the at least two trapped quantum particles is dependent on the magnitudes of the magnetic field, i.e. the magnetic field gradient. Since the coupling is proportional to a square of the magnetic field gradient, the magnetic field gradient has to be large enough to create sufficient coupling for fast computation, which can be realized with the permanent magnet arrangement described herein in combination with the soft magnetic material, in particular a structure of the soft magnetic material. This is to say that the magnetic field gradient has to be large enough to create a coupling being large compared to the decoherence rate. In particular, the soft magnetic material enhances the magnetic field of the permanent magnet arrangement in the region of the soft magnetic material and thus enhances the magnetic field gradient in comparison to the sole use of a permanent magnet arrangement.

In particular, the differences of the magnitudes of the magnetic field are advantageously increased approximately by the factor of 10 along the first axis due to the use of the soft magnetic material in comparison to the sole use of a permanent magnet arrangement. Therefore, also the magnetic field gradient is increased approximately by the factor of 10 along the first axis in comparison to the permanent magnet arrangement.

Such a comparatively large magnetic field gradient improves an addressing and provides a lower crosstalk and a stronger coupling of the trapped quantum particles in comparison to the sole use of a permanent magnet arrangement. Therefore, faster quantum operations are achievable and less error correction operations are required.

Advantageously, with the permanent magnet arrangement in combination with the soft magnetic material, the magnetic gradient is particularly high, while the available solid angle and distance with respect to the space of the trapped quantum particles is limited. Thus, such a quantum computing arrangement can be implemented in a variety of systems. This is to say that the permanent magnet arrangement can be comparatively far away from the space, wherein the soft magnetic material can be comparatively close to the space, providing the comparatively strong magnetic field gradient.

In sum, a permanent magnet arrangement is used involving a soft magnetic material, which can be a yoke structure, for obtaining large magnetic field gradients experienced by charged trapped quantum particles to create largely different magnetic fields seen by individual trapped quantum particles. In a quantum information environment this allows for advanced addressing in frequency space and thus individual single qubit rotations with low cross-talk, and to introduce a coupling between charged trapped quantum particles to allow for interactions, thus enabling multi-qubit gates. This can also be used in connection with radio frequency, RF, fields for qubit control, for which addressing by focussing radiation is not an option due to the long wavelength, but RF fields might offer advantages in terms of miniaturization, integration. For this purpose large or steep magnetic field gradients are desirable, allowing for better addressing and faster quantum gates with higher fidelity, and the permanent magnet arrangement, which is in particular a Halbach arrangement, allows for large magnetic field gradients even when the distance between segments of the permanent magnet arrangement and trapped quantum particles is limited from below by technical constraints. The yoke structures are placed in regions, where the magnetic field of the permanent magnet arrangement is already of small magnitude and concentrates it to the small cross section of the yoke structures without exceeding the saturation magnetization of the yoke structures, thus substantial boosting the magnitude of achievable magnetic field gradients, allowing for lower cross-talk, stronger couplings and faster quantum gates.

According to at least one embodiment of the quantum computing arrangement, the soft magnetic material is a ferromagnetic material configured to be magnetised by the magnetic field established by the permanent magnet arrangement.

According to at least one embodiment of the quantum computing arrangement, the soft magnetic material has a melting temperature of at least 500° C. The melting temperature is exemplarily represented by the temperature at which the soft magnetic material changes its state.

Exemplarily, the melting temperature of the soft magnetic material is at least 1000° C., approximately 1660° C.

According to at least one embodiment of the quantum computing arrangement, the soft magnetic material has a main extension direction along the first axis. Exemplarily, the soft magnetic material is elongated in the direction of the first axis. Due to such an elongation, the magnitude of the magnetic field is advantageously enhanced along the first axis, in particular in the region of the soft magnetic material.

According to at least one embodiment of the quantum computing arrangement, the soft magnetic material has a relative magnetic permeability of at least 300, in particular at least 1000. The relative magnetic permeability is the magnetic permeability of the soft magnetic material divided by the magnetic permeability of the free space.

Exemplarily, the relative magnetic permeability of the soft magnetic material is at least 10000 and at most 20000, in particular at least 11000 and at most 15000. For example, the relative magnetic permeability of the soft magnetic material is about 12000.

According to at least one embodiment of the quantum computing arrangement, the soft magnetic material has a saturation flux density of at least 1 T. Exemplarily, the saturation flux density of the soft magnetic material is at least 1.5 T and at most 5 T, in particular at least 2T and at most 3 T. For example, the saturation flux density of the soft magnetic material is about 2.4 T.

According to at least one embodiment of the quantum computing arrangement, the soft magnetic material comprises Iron, Cobalt and Vanadium. For example, the soft magnetic material further comprises at least one of the following materials: manganese, niobium, silicon, carbon.

According to at least one embodiment of the quantum computing arrangement, a concentration of iron and cobalt is bigger than a concentration of vanadium. For example, the concentration of iron and cobalt is at least 97% with respect to the soft magnetic material. The concentration of vanadium is at least 1.5% with respect to the soft magnetic material.

According to at least one embodiment of the quantum computing arrangement, a change of the magnitudes of the magnetic field along the first axis is at least 50 T/m. Exemplarily, the change of the magnitudes of the magnetic field along the first axis, in the region of the soft magnetic material, is at least 100 T/m and at most 500 T/m, in particular at least 200 T/m and at most 300 T/m.

According to at least one embodiment of the quantum computing arrangement, the permanent magnet arrangement comprises a plurality of segments, namely at least four segments. For example the permanent magnet arrangement comprises at least four segments, in particular at least 8 segments, at least 16 or at least 32 segments. Each segment comprises a permanent magnetic material. In particular, each of the segments comprises the same permanent magnetic material. Exemplarily, the permanent magnetic material comprises a ferromagnetic material.

Each segment is formed, for example, in one piece. Alternatively, each segment is formed from at least two sub-segments, wherein the at least two sub-segments have the same material and/or magnetisation properties.

In a preferred embodiment the first axis extends linearly from one of the segments to another of the segments being located directly opposite to said one of the segments with respect to the centre of the permanent magnet arrangement.

According to at least one embodiment of the quantum computing arrangement, each segment has a magnetisation direction. A magnetisation of each segment is defined by a vector field being representative of dipole moments of the respective permanent magnetic material. This is to say that the respective permanent magnetic material exhibits dipole moments. The vector field, in particular the dipole moments of the permanent magnetic material, define the respective magnetisation direction. The dipole moments largely point in the magnetisation direction.

According to at least one embodiment of the quantum computing arrangement, the magnetisation directions of segments being arranged at opposite regions are directed in opposite directions. The segments are arranged with respect to the centre of the permanent magnet arrangement at opposite regions. The magnetisation directions of segments being arranged at opposite regions are diametrical to one another.

If there are m segments, wherein m is an even natural number of at least 4, the magnetisation directions of the two directly neighbouring segments are rotated by 360°·3/m with respect to one another.

In particular, the first axis is defined with respect to two segments being arranged opposite to one another, wherein the magnetisation directions of the respective two segments are parallel to the first axis.

Exemplarily, the permanent magnet arrangement is a Halbach arrangement.

According to at least one embodiment of the quantum computing arrangement, the segments surround the space in the form of a ring, or the segments surround the space in the form of a contour of a polygon. The ring or the contour of the polygon are of virtual nature. Exemplarily, in cross-sectional view along the main extension plane, each segment is arranged on a point, wherein the points are located on the ring or the contour of the polygon. The points are spaced apart from one another, such that the sections also do not overlap with one another in the main extension plane. For example, each point is representative for a centre of a respective segment.

According to at least one embodiment of the quantum computing arrangement, a remanence of each of the segments is at least 0.1 T and at most 1.5 T. In particular, the remanence of each of the segments is at least 0.5 T and/or at most 1 T.

If the segments are arranged in the form of a ring, the magnetic flux density B corresponding to the magnetic field has the form:

$$\vec{B} = 2 {B}_{R} ( \frac{1}{{R}_{i}} - \frac{1}{{R}_{o}} ) ( \begin{matrix}1 & 0 \\ 0 & - 1\end{matrix} ) ( \begin{matrix}x \\ y\end{matrix} ) ,$$

wherein BR is the remanence of the segments, Ri the inner radius, Ro the outer radius and x and y the coordinates within the permanent magnet arrangement. Advantageously, the resulting magnetic field is further increased by the soft magnetic material in the region of the soft magnetic material, in particular along the first axis.

For example, edges of segments being arranged at opposite regions and facing one another have a minimal distance from one another of at least 0.001 cm and at most 100 cm. In particular, the minimal distance is at least 0.01 cm or at least 1 cm and at most 25 cm or at most 50 cm. In this context, opposite means, for example, opposite with respect to a centre of gravity of the permanent magnet arrangement and/or with respect to the centre of the magnetic field, i.e. a centre of the quadrupole field.

For example, the minimal distance divided by two is defined as an inner radius of the permanent magnet arrangement.

For example, each segment has an extent along the corresponding minimal distance of at least 0.001 cm and at most 100 cm. In particular, the extent is at least 0.01 cm or at least 1cm and at most 25 cm or at most 50 cm.

For example, the minimal distance divided by two and the extent along the corresponding minimal distance is defined as an outer radius of the permanent magnet arrangement.

According to at least one embodiment of the quantum computing arrangement, the soft magnetic material has a first part and a second part. The first part and the second part are spaced apart from one another along the first axis. Exemplarily, both the first part and the second part have an overlap with the first axis at some regions. Furthermore, both the first part and the second part have a main extension direction along the first axis.

Exemplarily, a distance along the first axis from the first part to the second part is at least 1 μm and at most 25 cm, in particular at least 50 μm and at most 5 cm.

According to at least one embodiment of the quantum computing arrangement, the first part and the second part form a yoke structure within the permanent magnet arrangement. For example, the first part is formed as one pole of the yoke structure and the second part is formed as another pole of the yoke structure. In particular, a magnetic structure of the yoke structure is induced by the magnetic field of the permanent magnet arrangement.

For example, the first part and the second part each has an end surface extending substantially perpendicular to the first axis, between which the space is located. Substantially perpendicular means that the end surface can have an angle of ±1° to the direction perpendicular to the first axis due to production tolerances. This is to say that the end surface of the first part and the end surface of the second part are arranged opposite to one another with respect to the space.

Typically magnetic field lines exit from the soft magnetic material perpendicular to the end surfaces. Exemplarily, the end surfaces each have a distance to the centre of the permanent magnet arrangement. The distances of the first part and the second part, in particular the end surfaces, to the centre are substantially equal to one another. “Substantially equal” means that the distances of the end surface to the centre can deviate by at most 50 μm, in particular at most 10 μm, from one another.

Thus, due to the end surface extending perpendicular to the first axis and the distances being equal to one another, the magnetic field lines of the first part and the second part meet advantageously in the centre of the permanent magnet arrangement, which also contributes to the increase of the differences of the magnitude of the magnetic field along the first axis, i.e. the magnetic field gradient.

According to at least one embodiment, the quantum computing arrangement further comprises an ion trap comprising a first end cap electrode and a second end cap electrode between which the space is located.

According to at least one embodiment of the quantum computing arrangement, the first part is formed as the first end cap electrode, and the second part is formed as the second end cap electrode. The first end cap electrode and the second end cap electrode are each configured to be supplied with a direct current, de for short. The first end cap electrode and the second end cap electrode are configured to trap the to-be-trapped quantum particles along the first axis, between the first end cap electrode and the second end cap electrode.

For example, the first end cap electrode and the second end cap electrode are provided with a metallic coating being electrically conductive. For example, the metallic coating of the first end cap electrode and the second end cap electrode comprises or consist of gold.

According to at least one embodiment, the quantum computing arrangement further comprises an ion trap for hosting the space comprising at least one substrate.

According to at least one embodiment of the quantum computing arrangement, the at least one substrate is formed to be electrically insulating, and the first part and the second part are embedded in the at least one substrate. The electrically insulating substrate is formed or consists of an electrically insulating material. “Embedded” means here that at least one outer surface of the first part and the second part is covered by the substrate. Exemplarily, all outer surfaces of the first part and the second part are covered by the substrate.

According to at least one embodiment, the quantum computing arrangement further comprises at least one additional permanent magnet arrangement. In particular, the quantum computing arrangement can comprise several additional permanent magnet arrangements. The additional permanent magnet arrangement can have the same dimensions and/or properties as the permanent magnet arrangement described herein above.

According to at least one embodiment, the quantum computing arrangement further comprises at least one additional soft magnetic material being surrounded by the at least one additional permanent magnet arrangement. The additional soft magnetic material can have the same shape and properties as the soft magnetic material described herein above.

According to at least one embodiment of the quantum computing arrangement, the permanent magnet arrangement has a rotated position relative to the additional permanent magnet arrangement. For example, the additional permanent magnet arrangement is arranged with respect to the permanent magnet arrangement in a rotated form, in particular an out of plane rotated form, such that an angle is enclosed by the respective main extension planes. This is that the additional main extension plane of the additional permanent magnet arrangement is rotated out of the plane of the main extension plane of the permanent magnet arrangement. Exemplarily, the angle can be between 0° and 180°, in particular 60°, 120° and/or 90°.

For example, the additional permanent magnet arrangement is rotated by 90° with respect to the permanent magnet arrangement, such that the respective main extension planes enclose an angle of 90°.

According to at least one embodiment of the quantum computing arrangement, the permanent magnet arrangement and the additional permanent magnet arrangement are parallel to each other.

Exemplarily, the first axis and the additional first axis are positioned parallel to one another.

Alternatively, the additional permanent magnet arrangement is arranged with respect to the permanent magnet arrangement in a rotated form, in particular an in plane rotated form. In this case, the main extension plane and the additional main extension plane are parallel to one another. For such an in plane rotation, an angle is enclosed by the respective first axis, i.e. the first axis and the additional first axis. Exemplary, the angle can be between 0° and 90°.

For example, the additional permanent magnet arrangement is rotated in plane by 90° with respect to the permanent magnet arrangement, such that the respective first axis enclose an angle of 90°. In this embodiment, the first axis and the additional first axis are positioned perpendicular to one another.

Such a arrangements comprising the permanent magnet arrangement and the additional permanent magnet arrangement exemplarily each forms-in terms of the magnetic field-a three dimensional confined space, e.g. a three dimensional gradient space.

For example, the additional soft magnetic material is arranged along an additional first axis of the additional permanent magnet arrangement.

Additionally, a quantum computer is specified, wherein the quantum computer comprises a quantum computing arrangement as described herein above. This is to say that the features concerning the quantum computer are also applicable for the quantum computing arrangement and vice versa.

The quantum computer is configured to perform quantum computing processes by using the quantum computing arrangement. The trapped quantum particles of the quantum computing arrangement can be controlled and manipulated particularly well with the permanent magnet arrangement described herein above, in order to perform predetermined quantum calculations.

### BRIEF DESCRIPTION OF THE DRAWINGS

In the following, the quantum computing arrangement is explained in more detail with reference to exemplary embodiments and the associated Figures.

FIGS. 1 and 2 each shows a cross-sectional view of a quantum computing arrangement according to an exemplary embodiment;

FIG. 3 shows an exemplary diagram of magnitudes of the magnetic field of a permanent magnet arrangement of a quantum computing arrangement according to an exemplary embodiment; and

FIG. 4 shows a quantum computer according to an exemplary embodiment.

### DETAILED DESCRIPTION OF ILLUSTRATIVE EMBODIMENTS

Elements that are identical, similar or have the same effect are given the same reference signs in the Figures. The Figures and the proportions of the elements shown in the figures are not to be regarded as true to scale. Rather, individual elements may be shown exaggeratedly large for better representability and/or for better comprehensibility.

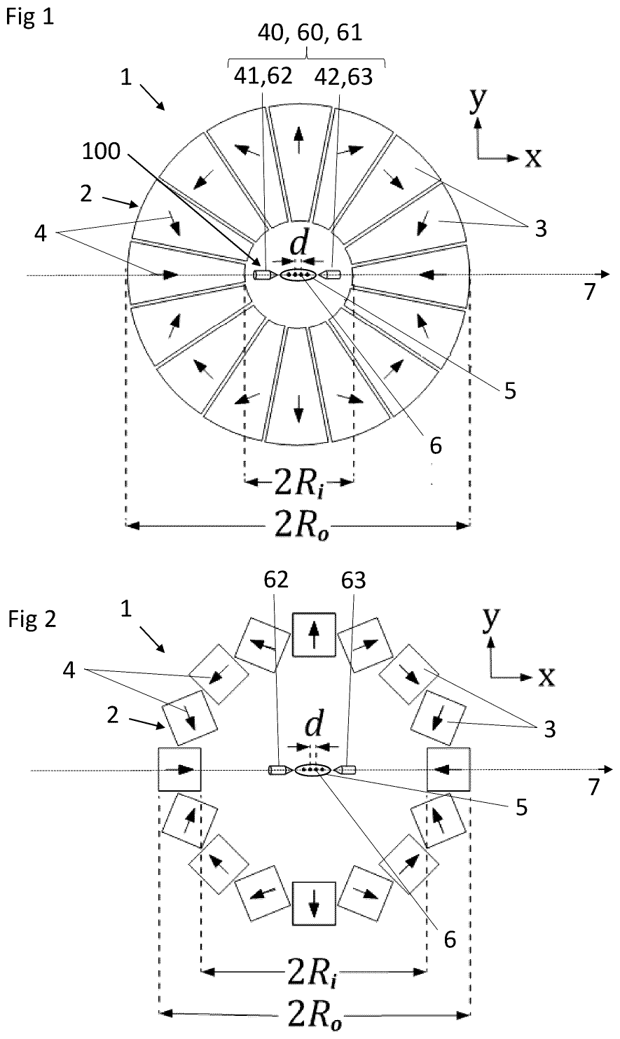

A quantum computing arrangement 1 according to the exemplary embodiment of FIG. 1 comprises a permanent magnet arrangement 2. The permanent magnet arrangement 2 comprises 16 segments 3. The segments 3 surround a space 5 of the quantum computing arrangement 1 where trapped quantum particles 6 are trapped during operation of the quantum computing arrangement 1. The segments 3 surround the space 5 in the form of a ring. Each segment 3 is arranged with its centre on a point of the ring.

The permanent magnet arrangement 2 has a main extension plane extending along the x-axis and y-axis shown in FIG. 1. Each segment 3 has the cross-sectional form of an annulus sector or circular ring sector, wherein all segments 3 share the same common inner ring and same common outer ring. A width of each segment 3 tapers down towards the space 5. That is that opposing edges of each segment 3 facing the space 5 are curved. A normal bundle of the curved edges point away from the space 5. This is to say that a radius of the curved edges are defined with respect to a centre region of the permanent magnet arrangement 2.

The curved edges of segments 3 being arranged at opposite regions with respect to the centre region and facing one another have a minimal distance from one another of approximately 10 cm. The minimal distance divided by two defines an inner radius Ri of the permanent magnet arrangement 2.

Furthermore, each segment 3 has an extent along the corresponding minimal distance being approximately 20 cm. The minimal distance divided by two and the extent along the corresponding minimal distance defines an outer radius Ro of the permanent magnet arrangement 2.

For example, directly neighbouring segments 3 are spaced apart from one another. Edges of directly neighbouring segments 3 facing one another have a distance to one another of approximately 1 mm.

In this exemplary embodiment, each segment 3 has a line of symmetry that is bisecting opposite edges facing the space 5. The line of symmetry is the same for segments 3 being arranged opposite one another. One of the lines of symmetry represents a first axis 7 of the permanent magnet arrangement 2, wherein the first axis 7 exemplarily extends within the main extension plane.

Furthermore, each segment 3 has a magnetisation direction 4 being depicted as arrows within the segments 3 in FIG. 1. The magnetisation directions 4 of segments 3 being arranged at opposite regions with respect to a centre of the permanent magnet arrangement 2 are directed in opposite directions. The first axis 7 of the permanent magnet arrangement 2 is defined with respect to two segments 3 being arranged opposite to each other, wherein the magnetisation directions 4 of the respective two segments 3 are parallel to the first axis 7.

Each magnetisation direction 4 encloses an angle with the first axis 7. All of these angles are formed differently. For example, the angles of directly neighbouring segments 3 differ by 67.5° from one another.

In the exemplary embodiments of the FIGS. 1 and 2, the first axis 7 points in the direction of the x-axis.

Furthermore, the angle of the segment 3 having a magnetisation direction 4 being parallel to the first axis 7 and pointing in the same direction as the first axis 7 is 0°. The angle of the opposite segment 3 having a magnetisation direction 4 being parallel to the first axis 7 and pointing in the opposite direction as the first axis 7 is 180°.

Going on the ring clockwise from the segment 3 having a magnetisation direction 4 being parallel to the first axis 7 and pointing in the same direction as the first axis 7 back to this segment 3, the magnetisation direction 4 also rotates clockwise.

With such segments 3, the permanent magnet arrangement 2 is configured to produce a quadrupole field and thus has different magnitudes along the first axis 7, i.e. a magnetic field gradient along the first axis 7. Further, during operation of the quantum computing arrangement 1 the trapped quantum particles 6 are arranged linearly next to one another along the first axis 7.

The magnitudes of the magnetic field, which act on the trapped quantum particles 6, are different for every trapped quantum particle 6 arranged on the first axis 7.

Furthermore, the permanent magnet arrangement 2 has a soft magnetic material 60 being arranged on the first axis 7. The soft magnetic material 60 has a first part 62 and a second part 63 being spaced apart from one another along the first axis 7. Furthermore, both the first part 62 and the second part 63 have a main extension direction along the first axis 7.

Exemplarily, the first part 62 is a first end cap electrode 41 and the second part 63 is a second end cap electrode 42 of an ion trap 100. In this case, the first end cap electrode 41 and the second end cap electrode 42 form a yoke structure 60.

The centre of the permanent magnet arrangement 2 is located between the first part 62 and the second part 63. This is to say that the space 5 is located between the first part 62 and the second part 63.

The magnetic field, in particular the magnitude of the magnetic field, of the permanent magnet arrangement 2 is increased by approximately 10 times in a region of the first part 62 and a region of the second part 63, whereas the magnitude of the magnetic field is zero at the center of the permanent magnet arrangement 2. This is to say that the difference of the magnitude of the magnetic field is increased along the first axis 7 from the first part 62 to the center and from the second part 63 to the center.

Advantageously, a particularly strong magnetic field gradient is achieved by such a quantum computing arrangement 1.

Exemplary, the trapped quantum particle 6 are trapped ions.

For example, the inner radius Ri according to this exemplary embodiment is approximately 5 cm and the outer radius Ro is approximately 25 cm. The remanence BR of each of the segments 3 is, for example, 1 T. Thus, the magnetic field, in particular the corresponding magnetic flux density \vec{B} can be calculated by:

$$\vec{B} = 2 {B}_{R} ( \frac{1}{{R}_{i}} - \frac{1}{{R}_{o}} ) ( \begin{matrix}1 & 0 \\ 0 & - 1\end{matrix} ) ( \begin{matrix}x \\ y\end{matrix} ) .$$

An origin of the coordinates x and y is located at the centre of the permanent magnet arrangement 2.

Furthermore, distances d of directly neighbouring trapped ions are approximately 3 μm. Thus, the magnetic flux density \vec{B} can be calculated for each position of the trapped ions. Consequently, also the difference for specific transitions between neighbouring trapped ions can be determined.

Exemplarily, a frequency difference of σ±-transitions between directly neighbouring trapped ions is at least 10 kHz and at most 100 MHz. σ±-transitions can be excited by a left-or right-circularly polarised electromagnetic wave with a polarization perpendicular to the local magnetic field.

For example, a frequency difference of π-transitions between directly neighbouring trapped ions is at least 1 kHz and at most 10 MHz. Such a π-transition is excited by a linearly polarised electromagnetic wave with a polarization parallel to the local magnetic field with a polarization parallel to the local magnetic field.

In contrast to the exemplary embodiment of FIG. 1, the quantum computing arrangement 1 according to the exemplary embodiment of FIG. 2 comprises a permanent magnet arrangement 2 having segments 3, each having a squared form.

Each segment 3 has a cross-sectional form of a square. The magnetisation directions 4 with respect to the edges of the squares are the same for each segment 3. Directly neighbouring segments 3 are rotated with respect to one another, such that the magnetisation directions 4 of each segment 3 corresponds to the angles according to FIG. 1.

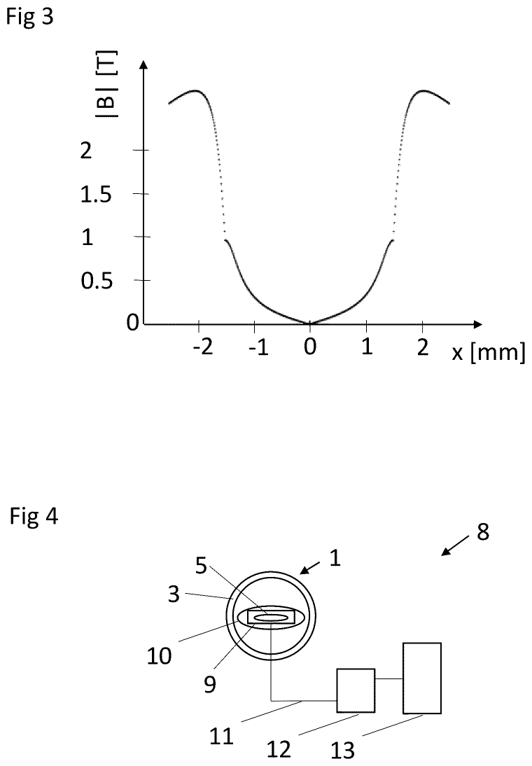

In FIG. 3, magnitudes of the magnetic field being represented by absolute values of a magnetic field |B| in T are illustrated on a vertical axis dependent on a position x in mm being illustrated on a horizontal axis, respectively.

The horizontal axis of the diagram shown in FIG. 3 corresponds to the x-axis according to FIGS. 1 and 2. The position x being equal to o corresponds to a centre of the permanent magnet arrangement 2 according to FIGS. 1 and 2.

With respect to the centre of the permanent magnet arrangement 2, the absolute values of the magnetic flux density | B|, i.e. the magnitudes of the magnetic field, are symmetric. For negative position values x, the absolute values of the magnetic flux density |B|, i.e. the magnitudes of the magnetic field, have a negative slope and for positive position values x a positive slope.

For a region around the centre of the permanent magnet arrangement 2 of ±250 μm, the differences of the magnitudes of the magnetic field are approximately linear. This results in a magnetic field gradient of about 200 T/m. The first part 62 and the second part 63 of the soft magnetic material 60 starts approximately at an x-position of about −2 mm and about 2 mm. This is to say that the distance of the first part 62 and the second part 63 along the first axis 7 is about 4 mm.

A quantum computer 8 according to the exemplary embodiment of FIG. 4 comprises a quantum computing arrangement 1 according to one of the exemplary embodiments of FIG. 1 or 2 as well as a quantum computing device 9 located within a chamber 10. The quantum computing device 9 is connected to external components of the quantum computer 8 through the chamber 10 by a plurality of connections 11. For example, the connections 11 connect the quantum computing device 9 with an external electronic 12 and a classical computer 13.

For example, the quantum computing device 9 is configured to trap, manipulate and measure trapped quantum particles 6, each being a qubit, within a space 5 during operation. For this, the quantum computing device 9 can comprise electrodes, light guides and/or internal electronics comprising electronic devices. The electronic devices can comprise circuitry, integrated electronic, and/or detectors, such as photon detectors and/or charge detectors, controllers. Exemplarily, the internal electronics are provided for pre-processing. For example, these components allow a measurement of a respective state of the qubits and allow gate operations on the qubits. Thus, the quantum computing device 9 is configured to trap the trapped quantum particles 6 as well as to carry out operations and measurements on the trapped quantum particles 6.

The quantum computing device 9 is mounted in the chamber 10, wherein the chamber 10 can be an ultra-high vacuum chamber, an extreme-high vacuum chamber and/or a cryostat. If the chamber 10 is an ultra-high vacuum chamber or an extreme-high vacuum chamber, it is possible that the permanent magnet arrangement 2 is arranged outside the chamber 10. In this case the permanent magnet arrangement 2 surrounds the chamber 10. Alternatively, it is also possible to arrange the permanent magnet arrangement 2 within an ultra-high vacuum chamber or an extreme-high vacuum chamber or a cryostat.

Exemplarily, if the chamber 10 is a cryostat, the permanent magnet arrangement 2 is arranged inside the chamber 10 (not shown here). It is also conceivable that if the chamber 10 is a cryostat, the permanent magnet arrangement 2 can be arranged also outside the chamber 10 (not shown here).

The quantum computing device 9 is connected to the external electronic 12 via the connections 11. The external electronic 12 can be located at least partially inside and partially outside the chamber 10. Further, the external electronic 12 is connected to the classical computer 13.

Exemplarily, the external electronic 12 comprises analog to digital converters as well as signal generators such as radio frequency generators, microwave signal generators, low-frequency signal generators and/or direct current signal generators. Furthermore, the external electronic 12 can comprise a transistor-transistor logic, TTL.

Additionally, the external electronic 12 can further comprise at least one laser system configured to cool the to-be-trapped ions. Further, the laser system can be configured to excite a particular state of the trapped ions.

The classical computer 13 is configured, for example, to provide and receive digital

signals. The digital signals correspond to control signals used for operations on the qubits as well as to measurement signals corresponding to a state of the qubits.

The external electronic 12 is, inter alia, configured to convert the digital signals to analog signals and vice versa. Therefore, the external electronic 12 is configured to provide the converted analog signals for manipulating the qubits to the quantum computing device 9. Further, the external electronic 12 is configured to provide measured analog signals from the quantum computing device 9 to the classical computer 13 or to process such signals to directly initiate some response signal generated by the control electronics 12.

The classical computer 13 is exemplarily configured to be provided with a specific algorithm, i.e. a predetermined quantum calculation solving a specific problem. The classical computer 13 is then configured to convert a compiled code, corresponding to the algorithm, to commands for the quantum computing device 9. The commands are subsequently forwarded via the external electronic 12 to the quantum computing device 9. Furthermore, the classical computer 13 is configured to receive a measured outcome of the specific algorithm.

For example, all elements of the quantum computer 8, in particular all electronic elements of the quantum computer 8, are synchronized by an atomic clock reference, for example.

The invention is not limited to the exemplary embodiments by their description. Rather, the invention encompasses any new feature as well as any combination of features, which in particular includes any combination of features in the claims, even if this feature or combination itself is not explicitly indicated in the claims or exemplary embodiments.

1-17. (canceled)

18. A quantum computing arrangement comprising:
a permanent magnet arrangement configured for establishing a magnetic field with magnitudes different from one another for different positions on a first axis;
a space for at least two trapped quantum particles arranged along the first axis; and
a soft magnetic material surrounded by the permanent magnet arrangement, the soft magnetic material configured for enhancing the magnetic field established by the permanent magnet arrangement,
wherein the permanent magnet arrangement comprises a plurality of segments,
wherein each segment has a magnetisation direction, and
wherein the segments surround the space in form of a ring, or
wherein the segments surround the space in form of a contour of a polygon.

19. The quantum computing arrangement according to claim 18, wherein the soft magnetic material is a ferromagnetic material magnetizable by the magnetic field.

20. The quantum computing arrangement according to claim 18, wherein the soft magnetic material has a melting temperature of at least 500° C.

21. The quantum computing arrangement according to claim 18, wherein the soft magnetic material has a main extension direction along the first axis.

22. The quantum computing arrangement according to claim 18,
wherein the soft magnetic material has a relative magnetic permeability of at least 1000, and/or
wherein the soft magnetic material has a saturation flux density of at least 1 T.

23. The quantum computing arrangement according to claim 18,
wherein the soft magnetic material comprises iron, cobalt and vanadium, and
wherein a concentration of iron and cobalt is greater than a concentration of vanadium.

24. The quantum computing arrangement according to claim 18, wherein a change of the magnitudes of the magnetic field along the first axis is at least 50 T/m.

25. The quantum computing arrangement according to claim 18, wherein the magnetisation directions of segments arranged at opposite regions are directed in opposite directions.

26. The quantum computing arrangement according to claim 18, wherein a remanence of each of the segments is at least 0.1 T and at most 1.5 T.

27. The quantum computing arrangement according to claim 18,
wherein the soft magnetic material has a first part and a second part, and
wherein the first part and the second part are spaced from one another along the first axis.

28. The quantum computing arrangement according to claim 27, wherein the first part and the second part form a yoke structure within the permanent magnet arrangement.

29. The quantum computing arrangement according to claim 27, further comprising:
an ion trap comprising a first end cap electrode and a second end cap electrode between which the space is located,
wherein the first part is the first end cap electrode, and
wherein the second part is the second end cap electrode.

30. Th quantum computing arrangement according to claim 27, further comprising:
an ion trap configured for hosting the space comprising at least one substrate,
wherein the at least one substrate is electrically insulating, and
wherein the first part and the second part are embedded in the at least one substrate.

31. The quantum computing arrangement according to claim 18, further comprising:
at least one additional permanent magnet arrangement; and
at least one additional soft magnetic material surrounded by the at least one additional permanent magnet arrangement.

32. The quantum computing arrangement according to claim 18, wherein the plurality of segments comprises at least four segments.

33. A quantum computer comprising:
the quantum computing arrangement according to claim 18,
wherein the quantum computer is configured for performing quantum computations.
